(19) United States
(12) Patent Application Publication
(10) Pub. No.: US 2021/0165380 A1
(43) Pub. Date: Jun. 3, 2021

(54) METHOD, DEVICE AND SYSTEM FOR INTELLIGENT HOUSEHOLD APPLIANCE TO ACCESS MULTIPLE SERVERS

(71) Applicant: Xiaomi Inc., Beijing (CN)

(72) Inventors: Yanlu ZHANG, Beijing (CN); Enxing Hou, Beijing (CN); Benchang Su, Beijing (CN)

(73) Assignee: Xiaomi Inc.

(21) Appl. No.: 17/170,018

(22) Filed: Feb. 8, 2021

Related U.S. Application Data
(63) Continuation-in-part of application No. 15/386,186, filed on Dec. 21, 2016.

(30) Foreign Application Priority Data
Dec. 22, 2015 (CN) 201510974376.7

(51) Int. Cl. G05B 19/042; G05B 19/418

(52) U.S. Cl. CPC G05B 19/0423; G05B 2219/2642; G05B 19/4185; G05B 19/0421

(57) ABSTRACT

A method for an intelligent household appliance to communicate with multiple servers, includes: accessing N servers, respectively, wherein N is an integer equal to or greater than 2, and the N servers belong to different manufacturers; and transmitting information related to the intelligent household appliance to the N servers.

### CROSS-REFERENCE TO RELATED APPLICATIONS

The present application is a continuation-in-part application of U.S. application Ser. No. 15/386,186, filed on Dec. 21, 2016, which is based upon and claims priority to Chinese Patent Application No. 201510974376.7, filed Dec. 22, 2015, the entire contents of all of which are incorporated herein by reference.

### TECHNICAL FIELD

The present disclosure generally relates to intelligent device technologies, and more particularly, to a method, device and system for an intelligent household appliance to access multiple servers.

### BACKGROUND

At present, household appliances have been more and more intelligent, and this has become a future development trend in the household appliance field. The intellectualization of a household appliance refers to incorporating a wireless communication chip, such as WiFi or Bluetooth chip which is capable of accessing the Internet directly or indirectly, into the household appliance to make the household appliance capable of accessing the Internet. In this way, not only users can check the operation status of the household appliance and control the appliance remotely using client software in mobile phones, but also servers can collect device information of the household appliance and recordings about users' operation on the household appliance.

Currently, manufacturers of household appliances are good at manufacturing the household appliances but are weak in wireless communication technologies. Thus, the manufacturers of household appliances need to incorporate wireless communication devices of another party into household appliances, to make the household appliances capable of accessing the Internet to transmit various information regarding the household appliances to servers. However, whether the various information regarding the household appliances should be transmitted to the servers belonging to the manufacturers of the household appliances or the servers belonging to the manufacturers of the wireless communication devices has become a focus of dispute now.

### SUMMARY

According to a first aspect of embodiments of the present disclosure, there is provided a method for an intelligent household appliance to communicate with multiple servers. The method includes: accessing N servers, respectively, wherein N is an integer equal to or greater than 2, and the N servers belong to different manufacturers; and transmitting information related to the intelligent household appliance to the N servers.

According to a second aspect of embodiments of the present disclosure, there is provided an intelligent household appliance. The intelligent household appliance includes a processor and a memory for storing instructions executable by the processor. The processor is configured to: access N servers, respectively, wherein N is an integer equal to or greater than 2, and the N servers belong to different manufacturers; and transmit information related to the intelligent household appliance to the N servers.

According to a third aspect of embodiments of the present disclosure, there is provided a system for an intelligent household appliance to communicate with multiple servers. The system includes an intelligent household appliance and N servers, wherein N is an integer equal to or greater than 2, and the N servers belong to different manufacturers; wherein the intelligent household appliance comprises: a processor; and a memory for storing instructions executable by the processor; wherein the processor is configured to: access the N servers, respectively; and transmit information related to the intelligent household appliance to the N servers.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for an intelligent household appliance to access multiple servers according to an exemplary embodiment.

FIG. 2 is a flow chart of a method for an intelligent household appliance to access multiple servers according to another exemplary embodiment.

FIG. 3 is a flow chart of a method for an intelligent household appliance to access multiple servers according to another exemplary embodiment.

FIG. 4 is a block diagram of a device for an intelligent household appliance to access multiple servers according to an exemplary embodiment.

FIG. 5 is a block diagram of a device for an intelligent household appliance to access multiple servers according to an exemplary embodiment.

FIG. 6 is a block diagram of a device for an intelligent household appliance to access multiple servers according to an exemplary embodiment.

FIG. 7 is a block diagram of a device for an intelligent household appliance to access multiple servers according to an exemplary embodiment.

FIG. 8 is a block diagram of a system for an intelligent household appliance to access multiple servers according to an exemplary embodiment.

FIG. 9 is a schematic diagram of a network architecture for cross-platform access of intelligent household appliances according to an exemplary embodiment.

Embodiments of the present disclosure have been presented by the above drawings, and detailed descriptions will be provided below. The drawings and text descriptions here are not for restricting the scope of the disclosure in any way but for explaining the concept of the present disclosure to one of ordinary skill in this art with particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

FIG. 1 is a flow chart of a method 100 for an intelligent household appliance to access multiple servers according to an exemplary embodiment. In the present embodiment, for example, the method 100 is applied in an intelligent household appliance. The method 100 includes the following steps.

In step 101, communication connections are established with N servers, wherein N is an integer equal to or greater than 2, and the N servers belong to different manufacturers.

In step 102, information related to the intelligent household appliance is generated.

In step 103, the information related to the intelligent household appliance is sent to the N servers.

In the present embodiment, the intelligent household appliance can establish communication connections with the N servers, wherein N is an integer equal to or greater than 2, and the N servers can belong to different manufacturers. For example, N equals to 3, one of the servers belongs to a manufacturer of the intelligent household appliance, another one of the servers belongs to a manufacturer which manufactures a device for implementing the method 100 (e.g., the device may be set in the intelligent household appliance), and yet another one of the servers belongs to a manufacturer which manages the intelligent household appliance. The manufacturer of the device for implementing the method 100 and the manufacturer which manages the intelligent household appliance may be the same one. Also for example, N can be equal to 2, one server belongs to the manufacturer which manufactures the intelligent household appliance, for example, Midea Group or Gree Electric Appliances Inc., and the like, and the other server belongs to the manufacturer which manages the intelligent household appliance by an application program, for example, Xiaomi Inc., and the like.

According to an embodiment, step 101 may be implemented by: obtaining communication addresses of the N servers which are preset in the intelligent household appliance; and according to the communication addresses of the N servers, establishing the communication connections with the N servers. The communication addresses of the N servers can be Internet Protocol (IP) addresses, or Media Access Control (MAC) addresses, and the like.

After the intelligent household appliance establishes communication connections with the N servers, the intelligent appliance can communicate with the N servers to transmit information. The intelligent household appliance can generate information related to the intelligent household appliance, and then send the generated information related to the intelligent household appliance to the N servers. In this way, all of the N servers can obtain the information related to the intelligent household appliance, and thus manufacturers can perform analysis on the information according to their own needs.

According to an embodiment, the above generated information related to the intelligent household appliance can include at least one of: information regarding operation performance of the intelligent household appliance and information regarding an operation activity of a user performed on the intelligent household appliance. The information regarding operation performance of the intelligent household appliance may include: information regarding operation parameters of the intelligent household appliance, and information regarding environment parameters when the intelligent household appliance is operating. For example, the intelligent household appliance is an air conditioner, and the information regarding the operation performance of the air conditioner can include: the temperature when the air conditioner is running, the operation duration, the temperature and humidity of the environment where the air conditioner is operating. The information regarding the operation activity of a user performed on the intelligent household appliance can include: the time when the air conditioner is started by the user, the operation duration set by the user, the temperature for operation set by the user, and the like.

According to an embodiment, step 103 can be implemented by the following approaches.

In a first possible implementation, after generating the information related to the intelligent household appliance, the intelligent household appliance sends the generated information related to the intelligent household appliance to the N servers in real time.

In a second possible implementation, the intelligent household appliance can send the information related to the intelligent household appliance to the N servers at a predefined time interval. For example, the intelligent sends the information related to the intelligent household appliance to the N servers every hour. The sent information related to the intelligent household appliance is generated within the hour.

In a third possible implementation, according to a predefined time interval corresponding to each of the servers, the intelligent household appliance sends the information related to the intelligent household appliance to the N servers. For example, N equals to 2, and a predefined time interval corresponds to a first server is 30 minutes, and a predefined time interval corresponds to a second server is one hour. The intelligent household appliance can send the first server the information related to the intelligent household appliance every 30 minutes which is generated within the 30 minutes, and send the second server the information related to the intelligent household appliance every hour which is generated within the hour.

In the method 100, communication connections are established with N servers, and information related to an intelligent household appliance is sent to the N servers after the information related to the intelligent household appliance is generated. Thus, the multiple servers can obtain the information related to the intelligent household appliance which is generated by the intelligent appliance to avoid the dispute between manufacturers.

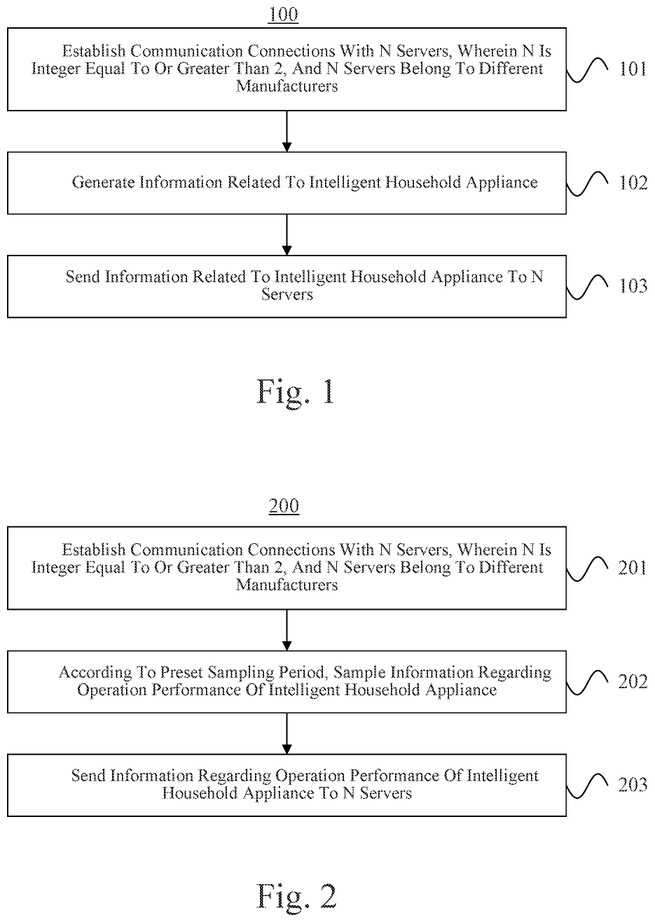

FIG. 2 is a flow chart of a method 200 for an intelligent household appliance to access multiple servers according to another exemplary embodiment. In the present embodiment, for example, the method 200 can be applied in an intelligent household appliance. The method 200 includes the following steps.

In step 201, communication connections are established with N servers, wherein N is an integer equal to or greater than 2, and the N servers belong to different manufacturers, similar to step 101 (FIG. 1).

In step 202, according to a preset sampling period, information regarding operation performance of the intelligent household appliance is sampled.

In the present embodiment, for example, the information related to the intelligent household appliance includes the information regarding operation performance of the intelligent household appliance, similar to the above description in connection with FIG. 1. For the information regarding operation performance of the intelligent household appliance, a sampling period can be set in advance, and then the information regarding the operation performance of the intelligent household appliance can be sampled according to the preset sampling period. For example, if the preset sampling period is 10 minutes, the information regarding the operation performance of the intelligent household appliance can be sampled once every 10 minutes.

In step 203, the information regarding the operation performance of the intelligent household appliance is sent to the N servers, similar to step 103 (FIG. 1).

In the method 200, communication connections are established with N servers, information regarding operation performance of the intelligent household appliance is sampled according to a preset sampling period, and then the information regarding operation performance of the intelligent household appliance is sent to the N servers. Thus, the multiple servers can obtain the information regarding operation performance of the intelligent household appliance which is generated by the intelligent appliance so as to avoid the dispute between manufacturers.

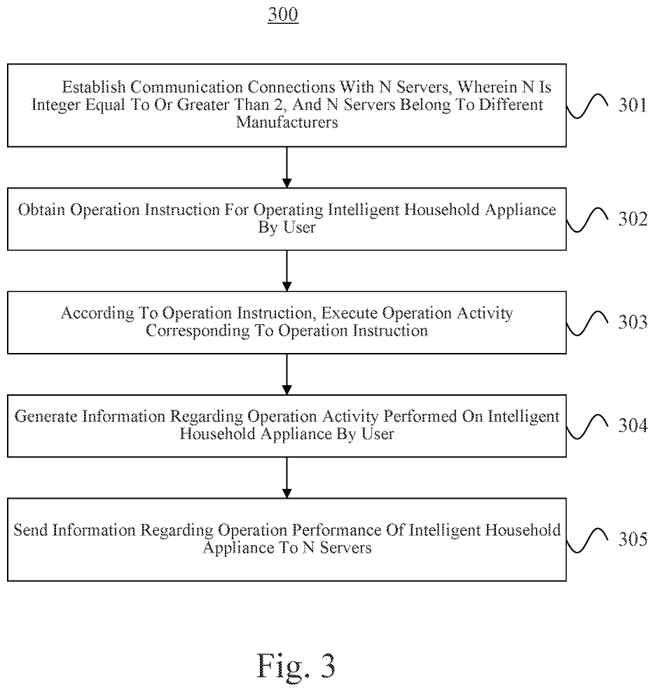

FIG. 3 is a flow chart of a method 300 for an intelligent household appliance to access multiple servers according to another exemplary embodiment. In the present embodiment, for example, the method 300 can be applied in an intelligent household appliance. The method 300 includes the following steps.

In step 301, communication connections are established with N servers, wherein N is an integer equal to or greater than 2, and the N servers belong to different manufacturers, similar to step 101 (FIG. 1).

In step 302, an operation instruction for operating the intelligent household appliance by a user is obtained.

In the present embodiment, the intelligent household appliance can obtain the operation instruction for operating the intelligent household appliance by the user. The operation instruction for operating the intelligent household appliance by the user can be an operation instruction sent by the user from a remote controller associated with the intelligent household appliance, or an operation instruction sent by the user from a management APP for managing the intelligent household appliance, or an operation instruction sent by the user via a touch screen or a button of the intelligent household appliance.

In step 303, according to the operation instruction, an operation activity corresponding to the operation instruction is executed.

In step 304, information regarding the operation activity performed on the intelligent household appliance by the user is generated.

In the present embodiment, after obtaining the operation instruction for operating the intelligent household appliance by the user, an operation activity corresponding to the operation instruction is executed, and then the information regarding the operation activity performed on the intelligent household appliance by the user is generated. For example, the intelligent household appliance is an air conditioner, the operation instruction instructs to set the operation temperature of the air conditioner as 25 degrees; as such, the intelligent household appliance sets the operation temperature of the air conditioner as 25 degrees, and generates information regarding the operation activity of adjusting the operation temperature of the air conditioner into 25 degrees by the user.

In step 305, the information regarding the operation activity performed on the intelligent household appliance by the user is sent to N servers, similar to step 103 (FIG. 1).

In the method 300, communication connections are established with N servers, an operation instruction for operating the intelligent household appliance by the user is obtained, an operation activity corresponding to the operation instruction is executed according to the operation instruction and the information regarding the operation activity performed on the intelligent household appliance by the user is generated, and then the information regarding the operation activity performed on the intelligent household appliance by the user is sent to N servers. Thus, the multiple servers can obtain the information regarding the operation activity performed on the intelligent household appliance by the user which is generated by the intelligent appliance so as to avoid the dispute between manufacturers.

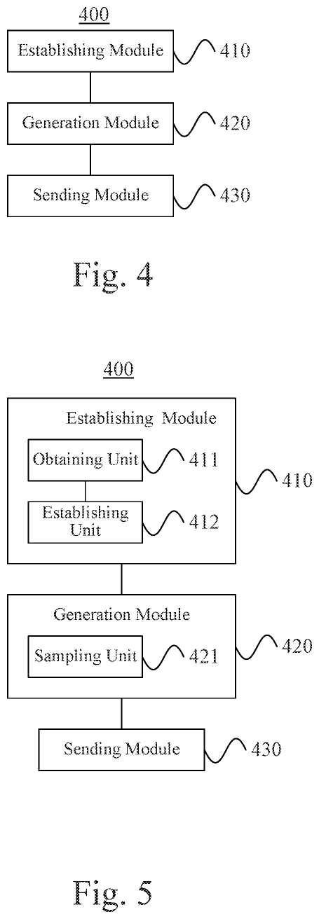

FIG. 4 is a block diagram of a device 400 for an intelligent household appliance to access multiple servers according to an exemplary embodiment. The device 400 can be implemented as a part or whole of an intelligent household appliance by software, hardware or a combination thereof. The device 400 can include an establishing module 410, a generation module 420, and a sending module 430.

The establishing module 410 is configured to establish communication connections with N servers, wherein N is an integer equal to or greater than 2, and the N servers belong to different manufacturers.

The generation module 420 is configured to generate information related to the intelligent household appliance.

The sending module 430 is configured to send the information related to the intelligent household appliance to the N servers.

According to an embodiment, the information related to the intelligent household appliance includes at least one of: information regarding operation performance of the intelligent household appliance and information regarding an operation activity of a user performed on the intelligent household appliance.

In the device 400 illustrated in FIG. 4, communication connections are established with N servers, and information related to an intelligent household appliance is sent to the N servers after the information related to the intelligent household appliance is generated. Thus, the multiple servers can obtain the information related to the intelligent household appliance which is generated by the intelligent appliance so as to avoid the dispute between manufacturers.

FIG. 5 is a block diagram of the device 400 (FIG. 4) for an intelligent household appliance to access multiple servers according to an exemplary embodiment. In the present embodiment, the information related to the intelligent household appliance includes the information regarding operation performance of the intelligent household appliance. The generation module 420 can include a sampling unit 421.

The sampling unit 421 is configured to, according to a preset sampling period, sample the information regarding operation performance of the intelligent household appliance.

The establishing module 410 includes an obtaining unit 411 and an establishing unit 412.

The obtaining unit 411 is configured to obtain communication addresses of the N servers which are preset in the intelligent household appliance.

The establishing unit 412 is configured to, according to the communication addresses of the N servers, establish the communication connections with the N servers.

In the device 400 illustrated in FIG. 5, communication connections are established with N servers, information regarding operation performance of the intelligent household appliance is sampled according to a preset sampling period, and then the information regarding operation performance of the intelligent household appliance is sent to the N servers. Thus, the multiple servers can obtain the information regarding operation performance of the intelligent household appliance which is generated by the intelligent appliance so as to avoid the dispute between manufacturers.

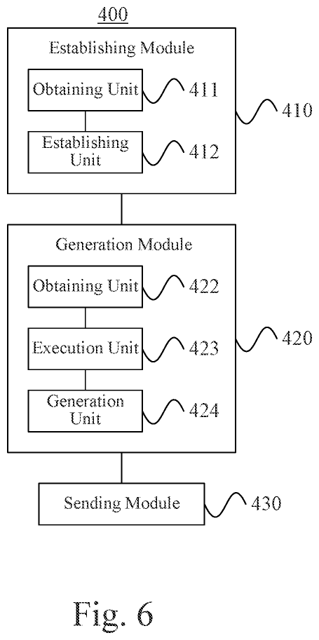

FIG. 6 is a block diagram of the device 400 (FIG. 4) for an intelligent household appliance to access multiple servers according to an exemplary embodiment. In the present embodiment, the information related to the intelligent household appliance includes the information regarding the operation activity of the user performed on the intelligent household appliance. The generation module 420 can include an obtaining unit 422, an execution unit 423, and a generation unit 424.

The obtaining unit 422 is configured to obtain an operation instruction for operating the intelligent household appliance by the user.

The execution unit 423 is configured to, according to the operation instruction, execute an operation activity corresponding to the operation instruction.

The generation unit 424 is configured to generate the information regarding the operation activity.

The establishing module 410 includes an obtaining unit 411 and an establishing unit 412.

The obtaining unit 411 is configured to obtain communication addresses of the N servers which are preset in the intelligent household appliance.

The establishing unit 412 is configured to, according to the communication addresses of the N servers, establish the communication connections with the N servers.

In the device 400 illustrated in FIG. 6, communication connections are established with N servers, an operation instruction for operating the intelligent household appliance by the user is obtained, an operation activity corresponding to the operation instruction is executed according to the operation instruction and the information regarding the operation activity performed on the intelligent household appliance by the user is generated, and then, the information regarding the operation activity performed on the intelligent household appliance by the user is sent to N servers. Thus, the multiple servers can obtain the information regarding the operation activity performed on the intelligent household appliance by the user which is generated by the intelligent appliance so as to avoid the dispute between manufacturers.

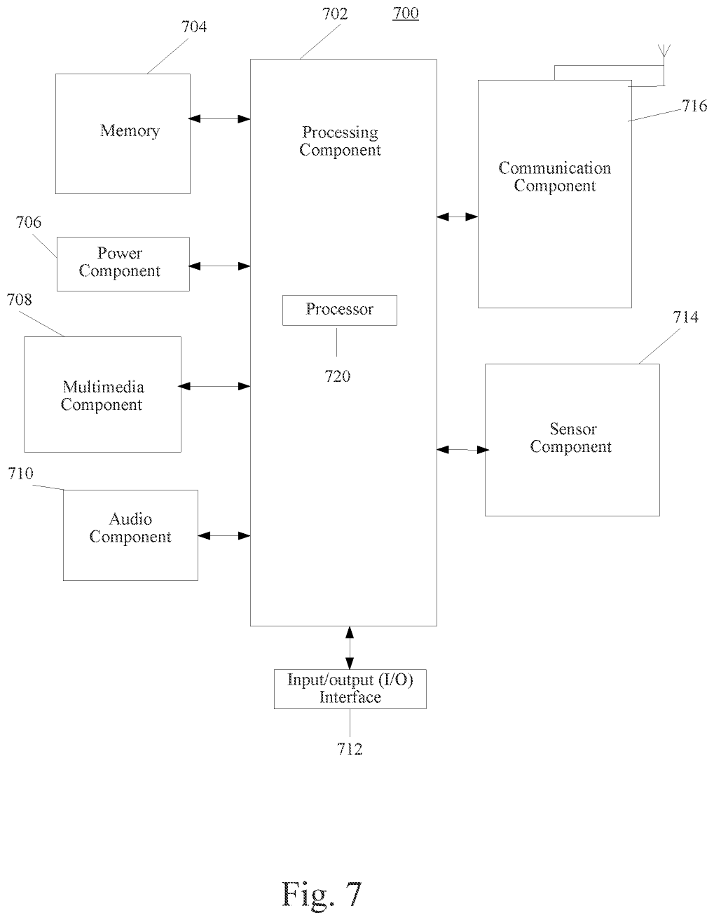

FIG. 7 is a block diagram of a device 700 for an intelligent household appliance to access multiple servers according to an exemplary embodiment. For example, the device 700 may be an apparatus used in the intelligent household appliance, or the intelligent household appliance such as a smart air conditioner, a smart refrigerator, or a smart TV and the like.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, data communications, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (“MIC”) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, or 3G, or a combination thereof. In one exemplary embodiment, the communication component 716 receives a broadcast signal or broadcast associated information from an external broadcast management system via a broadcast channel In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for online payment.

In exemplary embodiments, there is also provided a non-transitory computer-readable storage medium including instructions, such as included in the memory 704, executable by the processor 720 in the device 700, for performing the above-described methods. For example, the non-transitory computer-readable storage medium may be a ROM, a RAM, a CD-ROM, a magnetic tape, a floppy disc, an optical data storage device, and the like.

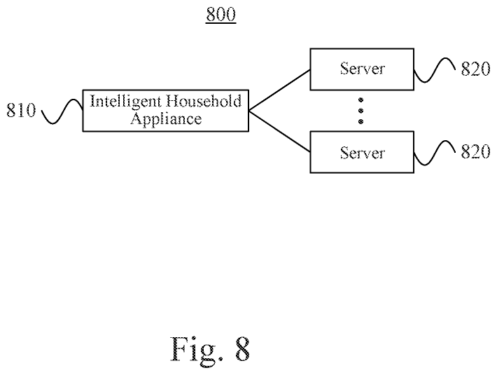

FIG. 8 is a block diagram of a system 800 for an intelligent household appliance to access multiple servers according to an exemplary embodiment. The system 800 includes an intelligent household appliance 810 and N servers 820.

The intelligent household appliance 810 can be any one of the devices described above in connection with FIGS. 4 to 7.

In exemplary embodiments, the above described methods and devices for an intelligent household appliance to access multiple servers may be used in a smart home control platform. An exemplary interaction between the intelligent household appliance and devices in the platform will be described below.

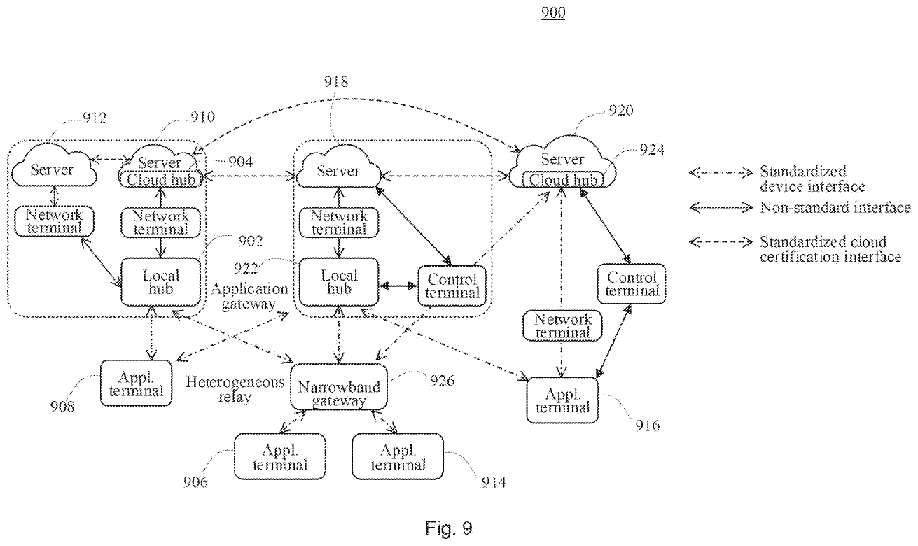

FIG. 9 is a schematic diagram of a network architecture 900 for cross-platform access of intelligent household appliances according to an exemplary embodiment. For example, the network architecture 900 may include a home hub to perform device connection, capability discovery, and linkage control, and serve as a control center of a smart home control platform.

In exemplary embodiments, the home hub may include at least one of a local hub 902 and a cloud hub 904 according to actual deployment locations. The local hub 902 may have a long-term online capability, and may be disposed in an intelligent household appliance, such as a smart speaker, a smart large screen, a home tablet, a smart router, and a home gateway. The local hub 902 may work independently and locally without interacting with a server 912. The cloud hub 904 may be developed in the a server 910. The server 912 in communication with the local hub 902 and the server 910 integrated in the cloud hub 904 may be among N servers belonging to different manufacturers, wherein N is an integer equal to or greater than 2. As shown in FIG. 9, an intelligent household appliance 908, for example, an application terminal of a manufacturer, may establish a communication connection with the local hub 902. The intelligent household appliance 908 is provided with a module with a wireless communication function, for example, a WiFi module, a ZigZee module, an NFC module, and so on. The intelligent household appliance 908 uses this module to establish a connection with the local hub 902, and transmits the information related to the intelligent household appliance to the local hub 902. The information related to the intelligent household appliance carries identification information for identifying the intelligent household appliance, for example, device ID information of the intelligent household appliance, network address information of the intelligent household appliance, and physical location information of the intelligent household appliance.

In exemplary embodiments, the local hub 902 may be integrated with a processor, an input/output module, and a wireless communication module, and the processor is electrically connected with the input/output module and the wireless communication module, respectively. The processor in the local hub 902 parses out the identification information from the received information related to the intelligent household appliance, and sends the parsed identification information to the server 912. Since the local hub 902 can parse out the identification information, when the local hub 902 simultaneously receives information sent by multiple intelligent household appliances, it can determine a correspondence between the received information and a corresponding intelligent household appliance. In addition, the processor in the local hub 902 also reports the received information related to the intelligent household appliance to the server 912. Therefore, by means of the local hub 902, an indirect connection between the intelligent household appliance and the server is realized.

In exemplary embodiments, the server 912 sends, via the connection with the local hub 902, a control instruction to the local hub 902. Then, the local hub 902 sends the control instruction to the intelligent household appliance 908, and the control instruction carries the identification information received from the local hub 902. For example, when the local hub 902 receives the control instruction, it may parse out the identification information from the control instruction, so as to send the control instruction to the corresponding intelligent household appliance.

In some embodiments, the intelligent household appliance 908 is pre-stored with manufacturer identification information of the server 912 and a communication address of the local hub 902, which may be preset, corresponding to the server 912. Therefore, when the intelligent household appliance 908 is to access the server 912, the intelligent household appliance 908 establishes a communication connection with the local hub 902 according to the communication address, thereby achieving indirect access to the server 912 by means of the local hub 902.

In some embodiments, the local hub 902 and the cloud hub 904 have server functions. For example, the intelligent household appliance 908 may only establish a connection with the local hub 902 or the cloud hub 904 according to the communication address.

In some embodiments, both the local hub 902 and the cloud hub 904 are deployed by the same manufacturer. However, the server 912 without the cloud hub 904 differentiates from the server 910 integrated in the cloud hub 904, wherein the server 910 integrated in the cloud hub 904 is capable of stronger authorities that can communicate with other servers 918 and 920 through standardized cloud certification interface. For example, if the local hub 902 deployed by a first manufacturer needs to communicate with a server 918 deployed by a second manufacturer, the communication connection can only be established via the connection between the local hub 902 deployed by the first manufacturer and the cloud hub 904 deployed by the first manufacturer, and a communication connection between the server 910 integrated in the cloud hub 904 deployed by the first manufacturer and the server 918 deployed by the second manufacturer. The cloud hub 904 deployed by the first manufacturer only communicates with the server 910 deployed by the first manufacturer, which means the authorities of the cloud hub 904 deployed by the first manufacturer is limited by interface and access limitations. Therefore, it may be necessary to deploy more than one server and hub device, so as to achieve diversified communication.

The communication address being preset in the intelligent household appliance 908 is only one way for the intelligent household appliance 908 to acquire the communication address. For example, the intelligent household appliance 908 may acquire the communication address by receiving broadcast information, or through a standardized device interface established in a standardized protocol. In other words, the intelligent household appliance 908 may acquire the communication address in any proper way, which is not limited by the present application.

The communications between the N servers may be established through standardized cloud certification interfaces. The servers 912, 918 and 920 may each be a cloud server or a local server, which is not limited by the present application.

In FIG. 9, the application terminal 908, an application terminal 906, an application terminal 914, an application terminal 916 belong to different manufacturers. In addition, the server 912, the server 918, and the server 920 belong to different manufacturers. The local hub 902 and a local hub 922 belong to different manufacturers, and the cloud hub 904 and a cloud hub 924 belong to different manufacturers. As show in FIG. 9, the application terminal 908, the local hub 902, the server 912, and the cloud hub 904 may belong to the same manufacturer. The application terminal 906 and the application terminal 914 may communicate with the local hub 922 via a narrowband gateway 926. The application terminal 916, the cloud hub 924, and the server 920 may belong to the same manufacturer. The embodiments of the present disclosure may be combined in any proper way.

In FIG. 9, dotted lines and dash dot lines represent device interfaces and authentication interfaces. The corresponding application terminals, heterogeneous relays, hub devices, and cloud service platforms are configured to support these interfaces to achieve cross-manufacturer device service interoperability.

In exemplary embodiments, multiple logical network elements may be deployed on the same physical network element. For example, a smart speaker can be used as the home hub and the control terminal at the same time, and also support a Bluetooth Mesh gateway function.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for an intelligent household appliance to communicate with multiple servers, comprising:
accessing N servers, respectively, wherein N is an integer equal to or greater than 2, and the N servers belong to different manufacturers; and
transmitting information related to the intelligent household appliance to the N servers.

2. The method according to claim 1, wherein the information related to the intelligent household appliance carries identification information for uniquely identifying the intelligent household appliance.

3. The method according to claim 1, wherein the accessing the N servers, respectively, comprises:
acquiring a communication address of a local hub in response to the local hub being deployed by a manufacturer;
establishing a communication connection with the local hub according to the communication address; and
accessing a server belonging to the manufacturer via the communication connection with the local hub, and a communication connection between the local hub and the sever belonging to the manufacturer.

4. The method according to claim 1, wherein the accessing the N servers, respectively, comprises:
acquiring a communication address of a server, wherein the server is only located in a local hub; and
establishing a communication connection with the server according to the communication address.

5. The method according to claim 1, wherein the accessing the N servers, respectively, comprises:
acquiring a communication address of a server, wherein the server is only located in a cloud hub; and
establishing a communication connection with the server according to the communication address.

6. The method according to claim 1, wherein the accessing the N servers, respectively, comprises:
acquiring a communication address of a local hub in response to the local hub and a cloud hub being deployed by a manufacturer;
establishing a communication connection with the local hub according to the communication address; and
accessing a server in the cloud hub via a communication connection between the local hub and a sever belonging to the manufacturer, and a communication connection between the server belonging to the manufacturer and the server in the cloud hub.

7. The method according to claim 1, the N servers comprise a first server belonging to a manufacturer of the intelligent household appliance, and a second server belonging to a manufacturer which manages the intelligent household appliance.

8. An intelligent household appliance, comprising:
a processor; and
a memory for storing instructions executable by the processor;
wherein the processor is configured to:
access N servers, respectively, wherein N is an integer equal to or greater than 2, and the N servers belong to different manufacturers; and
transmit information related to the intelligent household appliance to the N servers.

9. The intelligent household appliance according to claim 8, wherein the information related to the intelligent household appliance carries identification information for uniquely identifying the intelligent household appliance.

10. The intelligent household appliance according to claim 8, wherein the processor is configured to:
acquire a preset communication address of a local hub in response to the local hub being deployed by a manufacturer;
establish a communication connection with the local hub according to the preset communication address; and
access a server belonging to the manufacturer via the communication connection with the local hub, and a communication connection between the local hub and the sever belonging to the manufacturer.

11. The intelligent household appliance according to claim 8, wherein the processor is configured to:
acquire a communication address of a server, wherein the server is only located in a local hub; and
establish a communication connection with the server according to the communication address.

12. The intelligent household appliance according to claim 8, wherein the processor is configured to:
acquire a communication address of a server, wherein the server is only located in a cloud hub; and
establish a communication connection with the server according to the communication address.

13. The intelligent household appliance according to claim 8, wherein the processor is configured to:
acquire a preset communication address of a local hub in response to the local hub and a cloud hub being deployed by a manufacturer;
establish a communication connection with the local hub according to the preset communication address; and
access a server in the cloud hub via a communication connection between the local hub and a sever belonging to the manufacturer, and a communication connection between the server belonging to the manufacturer and the server in the cloud hub.

14. The intelligent household appliance according to claim 8, wherein the N servers comprise a first server belonging to a manufacturer of the intelligent household appliance, and a second server belonging to a manufacturer which manages the intelligent household appliance.

15. A system for an intelligent household appliance to communicate with multiple servers, comprising:
an intelligent household appliance; and
N servers, wherein N is an integer equal to or greater than 2, and the N servers belong to different manufacturers;
wherein the intelligent household appliance comprises:
a processor; and
a memory for storing instructions executable by the processor;
wherein the processor is configured to:
access the N servers, respectively; and
transmit information related to the intelligent household appliance to the N servers.
